(19) United States
(12) Patent Application Publication
(10) Pub. No.: US 2010/0073172 A1
(43) Pub. Date: Mar. 25, 2010

(54) DUAL CONDITION FIRE/SMOKE DETECTOR WITH ADJUSTABLE LED CANNON

(75) Inventor: Samuel Lax, Mission Hills, CA (US)

Correspondence Address: KELLY LOWRY & KELLEY, LLP, 6320 CANOGA AVENUE, SUITE 1650, WOODLAND HILLS, CA, 91367, US

(73) Assignee: L.I.F.E. SUPPORT TECHNOLOGIES, LLC, Mission Hills, CA (US)

(21) Appl. No.: 12/237,623

(22) Filed: Sep. 25, 2008

(51) Int. Cl. G08B 17/12; G08B 17/10

(52) U.S. Cl. 340/578; 340/630

(57) ABSTRACT

A dual condition fire/smoke detector system includes a housing and a sensor comprising at least two of a photoelectric sensor, a heat sensor, an ionization sensor or a carbon monoxide sensor disposed within the housing. A wireless communication system associated with the sensor enables communication of the detector with a remote device via a wireless receiver and a wireless transmitter. A light source associated with the housing may be positioned to illuminate an exit in response to a hazard detected by any of the aforementioned sensors.

### BACKGROUND OF THE INVENTION

The present invention relates to a dual condition fire/smoke detector with adjustable LED cannon. More particularly, the invention relates to fire/smoke detector capable of communicating with other fire/smoke detectors to cooperatively indicate an escape route by coordinating individual adjustable LED cannons.

Smoke alarms and detectors are generally well known in the art. One example of a modern smoke alarm is disclosed in U.S. Pat. No. 4,827,244 to Bellavia et al. Bellavia discloses a system for testing a remotely located detection unit. This is accomplished by using a flashlight or other item capable of directing a beam of radiant energy toward a photo sensor located on the detector unit. U.S. Pat. No. 4,166,960 to Meilla discloses a smoke detector having a radiation source for producing a directed radiation beam capable of sensing scattered smoke particles therein. Blockage of the radiation beam within the smoke detector causes the smoke detector to activate. Typically, smoke detectors activate an audible alarm or other alert means to notify nearby people of a fire or other hazard.

Improved smoke detectors not only sound an alarm when smoke is detected, but also activate powerful lights or flashing strobes designed to help direct people to an exit. U.S. Pat. No. 4,649,376 to Frank, for example, discloses a smoke alarm system that mounts to a ceiling and has an audible and visual alarm. Special high intensity lamp units are mounted in remote relationship to the detector and are designed to illuminate exits with powerful xenon lamps. The flashing lights are capable of piercing thick smoke to provide direction. Furthermore, U.S. Pat. No. 4,148,023 to Elkin, U.S. Pat. No. 4,570,155 to Skarman et al. and U.S. Pat. No. 4,763,115 to Cota provide further examples of emergency exit indicators that illuminate in response to a hazard detected by a smoke alarm. Each of these devices may include a light bulb designed to pierce smoke generated by a fire while simultaneously issuing an audible alarm or directions to an exit. While these devices can be useful in some circumstances, the flashing incandescent lights can daze or confuse people rather than provide direction. It can be particularly difficult to identify the origination of flashing lights in a smoky room. Furthermore, intense flashing lights also destroy night vision and often confuse people trying to escape from a dark building, thereby inhibiting the ability to safely and quickly escape from a hazard.

Cota further discloses the use of a redundant circuit activated by a central audio alarm that triggers the smoke alarm and flashing circuits therein. The corresponding guiding lamp is located near an exit and is visible from the floor. The unit activates in response to an audio alarm issued from a remote fire or smoke detector. The unit illuminates and provides audio guidance to an exit. Likewise, U.S. Pat. No. 5,572,183 to Sweeney discloses a laser-like fire evacuation system having a source laser light directed into multiple vertical columns that sequences the laser beam toward an exit. The laser beam increases in perceived intensity and consistency as smoke density increases. The laser beam may be directed toward rotating mirrors that redirect light accordingly to illuminate an exit. Each mirror directs the laser beam into the floor at different locations, thereby “walking” the beam toward an exit. Ideally, a user follows the “walking” beam toward the exit in the event of a hazard. Additionally, U.S. Pat. No. 5,140,301 to Watanabe discloses a guidance system for providing emergency evacuation with a laser. The laser is directed toward an exit from the interior of the building. In the event a hazard is detected, the control unit communicates with the laser so the laser can activate and provide direction to the exit. The centrally controlled network generates the laser beam capable of providing guidance to the exit by use of an oscillating control mirror.

The prior art further discloses in U.S. Pat. No. 6,181,251 to Kelly, for example, a combination smoke detection device and laser escape indicator. The combination indicator includes a means for detecting smoke and a laser for directing to or identifying an exit within a room or building. Multiple detection devices may be networked within a building without installing a centrally managed fire alarm system. The second (or multiple) smoke detection device includes a second laser that generates a second laser beam to trigger a laser sensor mounted on any one of a plurality of smoke detection devices. This system requires a line-of-sight between the second laser beam and the laser sensor. When properly mounted to the ceiling, the network of smoke detection devices in Kelly is unable to communicate with other devices outside a room unless the laser beam was able to penetrate walls, bend around corners or penetrate floors or ceilings. In this regard, any obstruction in the way of the laser beam (e.g. resulting from a fire hazard) would prevent the laser sensor from activating a second smoke detection device. This is particularly disadvantageous as the identification of a hazard in one part of a building could not be communicated to a person in another part of the building (e.g. a separate floor).

There exists, therefore, a significant need for a dual condition fire/smoke detector having an adjustable LED cannon. Such a fire/smoke detector should include an early warning activation system including a heat detector and a smoke detector, should include an adjustable LED cannon for illuminating an exit, should be capable of wirelessly communicating with other detectors and should be able to cooperatively alert and direct users toward an exit. The present invention fulfills these needs and provides further related advantages.

### SUMMARY OF THE INVENTION

The present invention is for a dual condition fire/smoke detector system. The system includes a fire/smoke detector having a housing with a photoelectric sensor and a heat sensor disposed therein. In another embodiment of the present invention, the fire/smoke detector includes a sensor comprising at least two of a photoelectric sensor, a heat sensor, an ionization sensor or a carbon monoxide sensor disposed within the housing. Additionally, the fire/smoke detector may include a means associated with the sensors for minimizing false alarms. Any of the aforementioned sensors and the false alarm minimization means provide enhanced early warning notification of fire hazards while preventing false alarms.

The dual condition fire/smoke detector system further includes a wireless communication system associated with the photoelectric sensor and the heat sensor. Alternatively, the wireless communication system may be associated with at least two of the photoelectric sensor, the heat sensor, the ionization sensor or the carbon monoxide sensor. The wireless communication system preferably includes a wireless receiver and a wireless transmitter that communicate by radio frequency, Bluetooth or Wi-Fi. Multiple fire/smoke detectors communicate among one another or with a central controller via the wireless communication system. In this embodiment, multiple detectors are capable of communicating with one another to identify an exit.

The dual condition fire/smoke detector may further include a light source associated with the housing and positioned to illuminate an exit in response to a hazard detected by any of the aforementioned sensors. The light source may further be rotatable and capable of automatically illuminating a path to the exit. In this regard, the light source may comprise a high-intensity LED, a laser cannon, a light or a strobe. The detector remains powered by a power supply comprising a hard wire connection to an alternating current or a battery disposed within the housing. The housing may further include a lock for releasibly retaining the battery in the housing by a spring loaded arm that engages the battery. A speaker may provide an audible alarm in response to a hazard detected by any of the sensors or audible notification that the battery is low.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a dual condition detector in accordance with the present invention;

FIG. 2 is a perspective view of the dual condition detector, illustrating an angled laser cannon;

FIG. 3 is a perspective view of the dual condition detector, illustrating battery storage commonly used in shipping;

FIG. 4 is another perspective view of the dual condition detector, illustrating electrically coupling the battery to the detector;

FIG. 5 is a perspective view of a mount plate in accordance with the present invention;

FIG. 6 is a partially exploded perspective view of the dual condition detector of the present invention;

FIG. 7 is a perspective view of the dual condition detector, illustrating engagement of the mount plate;

FIG. 8 is another perspective view illustrating attachment of the mount plate to the dual condition detector;

FIG. 9 is an alternative perspective view illustrating attachment of the mount plate to the dual condition detector, offset by one hundred eighty degrees relative to FIG. 8;

FIG. 10 is an assembled perspective view of the dual condition detector of the present invention;

FIG. 11 is a partial perspective view of a locked battery;

FIG. 12 is a partial perspective view of an unlocked battery;

FIG. 13 is a partial exploded perspective view illustrating unlocking and removing the battery from the dual condition detector; and

FIG. 14 is a schematic view illustrating communication between two dual condition detectors of the present invention.

### DETAILED DESCRIPTION OF THE PREFERRED EMBODIMENTS

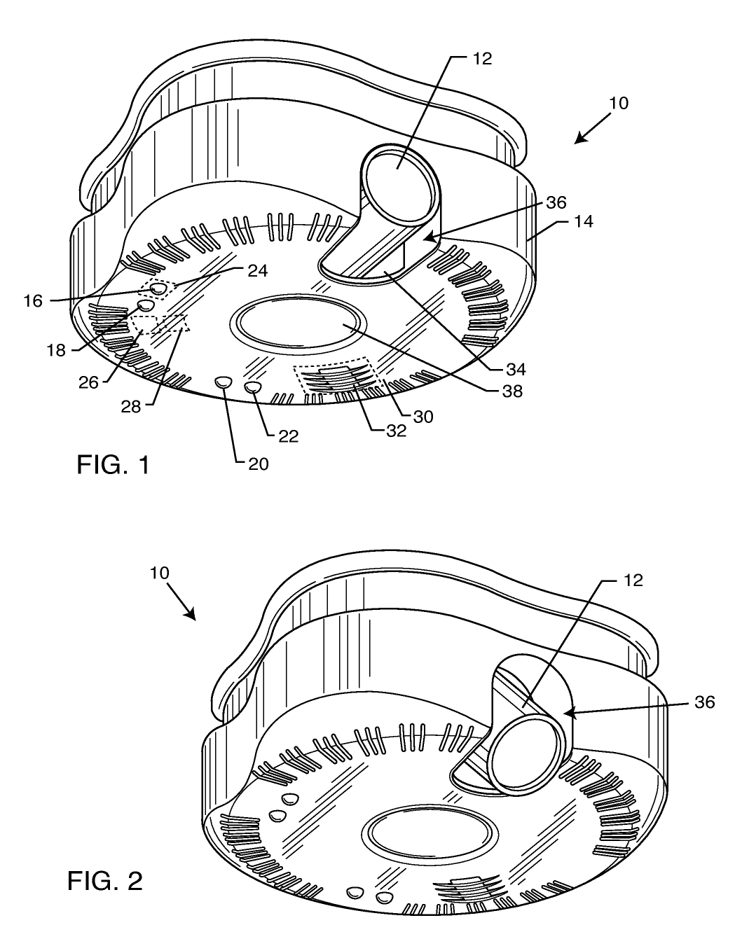

As shown in the drawings for purposes of illustration, the present invention for a dual condition detector is referred to generally by the reference number 10. In FIG. 1, the dual condition detector 10 is shown including a light cannon 12 within an outer case 14 of the dual condition detector 10. Protruding from the outer case 14 includes a sensor LED 16, a transmitter/receiver LED 18, a power indicator LED 20 and a battery indicator LED 22. Accordingly, the dual condition detector 10 is equipped with any one of a number of sensors (designated by the sensor circuitry 24 in FIG. 1) that include a photoelectric sensor, an ionization sensor, a heat sensor or any other smoke or fire sensor known in the art. These sensors 24 (one or more) are electrically coupled to the sensor LED 16 for providing external notification regarding the operating condition of the sensor 24. The dual condition detector 10 may include multiple sensor LEDs 16 for each sensor 24. Preferably, the dual condition detector 10 at least includes a photoelectric sensor and a heat sensor. The photoelectric sensor is particularly ideal for detecting smoldering fires that produce smoke. The heat sensor is particularly ideal for detecting fires with large flames that produce heat reaching upwards of 130 degrees Fahrenheit (° F.). The photoelectric sensor and the heat sensor operate separately and independently. Combining sensors enhances detection of hazards associated with fires. Furthermore, the transmitter/receiver LED 18 is coupled to a wireless transmitter circuitry 26 and/or a wireless receiver circuitry 28 located within the interior of the outer case 14. The purpose of the wireless transmitter circuitry 26 and the wireless receiver circuitry 28, as described in more detail below, is to allow multiple dual condition detectors 10 to communicate with one another. Accordingly, the power indicator LED 20 and the battery indicator LED 22 provide external notification of the operating state of the power supply and battery, respectively, as supplied to the sensor circuitry 24 of the dual condition detector 10.

The light cannon 12 of the dual condition detector 10 preferably emits a directional LED beam. The light cannon 12 activates when the sensor circuitry 24 detects a hazard. For example, the photoelectric sensor reacts to slow, smoldering fires that typically develop over a long time period. These fires produce significant smoke with little heat before bursting into flames. The heat sensor, on the other hand, detects heat emitted from a fire having large flames. Upon detection of the hazard, the dual condition detector 10 activates, thereby producing an audible alarm via a speaker circuitry 30 through a vent 32 located in the outer case 14. The light cannon 12 illuminates the safest exit within a particular room or structure as determined at the time of installation. The light cannon 12 can be easily adjusted and placed into position regardless whether the dual condition detector 10 is mounted to a wall or a ceiling. In one embodiment of the present invention, as shown in FIG. 1, the light cannon 12 is coupled to an adjustable hinge 34 integral to the dual condition detector 10. In this embodiment, the light cannon 12 pivots about the hinge 34 within a chamber 36. The hinge 34 is less versatile than mounting the light cannon 12 to a flexible arm and rotatable base as shown and described in U.S. patent application Ser. No. 12/187,500, the contents of which are herein incorporated by reference. But, the chamber 36 provides a robust housing for the light cannon 12 within the outer case 14 of the dual condition detector 10. Thus, the light cannon 12 is substantially shielded from the environment by the chamber 36 while simultaneously being adjustable via the hinge 34 without having to remove the outer case 14.

The speaker circuitry 30 issues an audible alarm when the sensor circuitry 24 detects a hazard. Preferably, a loud tone (100+ decibels (dB) at ten feet) issues from the vent 32 to alert surrounding individuals of a nearby emergency. In the event of a false alarm, the dual condition detector 10 includes a mute button 38 which can temporarily silence the speaker circuitry 30 issuing the audible alarm. The mute button 38 also doubles as a test button 38, as described in more detail below. The mute button 38 is particularly useful in kitchen areas or other locations prone to nuisance alarms. When the mute button 38 is pressed while the alarm is sounding, the dual condition detector 10 is preferably silenced for a predetermined duration, such as fifteen minutes. The mute function of the dual condition detector 10 should only be used when a known alarm condition activates the alarm. Pushing the mute button 38 desensitizes the sensor circuitry 24 if the smoke sensed by the sensor circuitry 24 is not too dense. Thereafter, the audible alarm issued by the speaker circuitry 30 ceases and “chirps” intermittently. Also, the sensor LED 16 may flash intermittently (e.g. every thirty to forty seconds) for the predetermined duration (e.g. fifteen minutes). The chirping and intermittent flashing of the sensor LED 16 provides audible and visual notification that the alarm is temporarily desensitized. The dual condition detector 10 automatically resets itself after expiration of the desensitization duration programmed into the internal circuitry. The speaker circuitry 30 will reactivate the alarm if the combustion particles are still present. The dual condition detector 10 will remain silent if the sensor circuitry 24 no longer detects a threshold quantity of combustion particles that would otherwise cause the dual condition detector 10 to activate. Accordingly, the mute button 38 may be pressed repeatedly until the air surrounding the sensor circuitry 24 is cleared of the condition causing the false alarm. The dual condition detector 10 may be programmed to override the mute button 38 in the event that the sensor circuitry 24 continues to detect dense smoke or another high concentration of combustion particles. Here, the speaker circuitry 30 continues to issue an audible alarm.

The mute button 38 may also be utilized as a test button 38 to check the operation of the dual condition detector 10. In a preferred embodiment, the dual condition detector 10 is tested weekly with the test button 38 to ensure proper operation of the circuitry 24, 26, 28, 30. For example, the test button 38 may be utilized to ensure proper installation and operation of the dual condition detector 10. Pressing the test button 38 for approximately three seconds initiates the testing sequence. The dual condition detector 10 activates the speaker circuitry 30 (issuing an audible horn) and activates the light cannon 12 (providing visual direction to an exit). The testing sequence may remain activated for up to three seconds after releasing the test button 38. The dual condition detector 10 immediately initiates a testing cycle to ensure proper operation of the circuitry 24, 26, 28, 30, the LEDs 16, 18, 20, 22 and any other electronic device integrated into the dual condition detector 10 for communicating, identifying, detecting or alerting users of a potential hazard. The dual condition detector 10 provides visual, audible and electrical testing. For example, the power indicator LED 20 may blink or flash once approximately every minute to indicate that the unit is receiving AC or DC power. The battery indicator LED 22 may also blink or flash once approximately every minute to indicate that the battery is electrically coupled to and capable of powering the dual condition detector 10. If the battery indicator LED 22 senses that the internal battery is low, the speaker circuitry 30 will issue an audible alarm comprising a short beep once every minute or so to notify the user that the battery needs to be replaced. Otherwise, the power indicator LED 20 and the battery indicator LED 22 will flash once approximately every minute to indicate that the dual condition detector 10 is receiving power from each source. Hence, a user is able to quickly, visually and audibly verify the proper functionality of the dual condition detector 10 of the present invention.

The dual condition detector 10 is designed to minimize false alarms through the implementation of a False Alarm Analysis System. The False Alarm Analysis System analyzes every signal sensed by the sensor circuitry 24 before sounding an alarm. The False Alarm Analysis System endeavors to reduce the probability of false alarms associated with low quantities of cigarette smoke or smoke generated while cooking. For example, traditional smoke detectors are prone to issuing false alarms in areas where relatively small quantities of combustion particles are present. These areas might include poorly ventilated kitchens, garages and areas near furnaces, water heaters, wood-burning stoves or fireplaces. Cigarette smoke will not normally activate the dual condition detector 10 unless the smoke is blown directly into the unit. Combustion particles from cooking may set off the dual condition detector 10 if the dual condition detector 10 is located close to the cooking area. For example, large quantities of combustible particles are generated from spills or during boiling. Vents in range hoods that have a fan for removing such combustible particles to the outside (non-re-circulating type) help reduce the risk of activating a false alarm with the dual condition detector 10. Other areas that may induce false alarms include damp or extremely humid areas such as bathrooms with showers, where normal humidity may rise above ninety percent relative humidity or drop below ten percent relative humidity. Areas with humidity above or below these levels of relative humidity can cause a false alarm. The False Alarm Analysis System is designed to enable a user to place the dual condition detector 10 as close to potential fire hazards as possible while simultaneously preventing nuisance alarms. The False Alarm Analysis System is also designed to prevent false alarms in dusty, dirty or insect infested areas. But, it is preferred in the present invention that the dual condition detector 10 be installed at distances that minimize interference of the aforementioned particles with the sensor circuitry 24 to prevent false alarms, regardless of the False Alarm Analysis System.

The dual condition detector 10 may specifically be powered by either alternating current (AC) or by direct current (DC), depending on the voltage in the country of use. The power source of choice is coupled to the power indicator LED 20. The dual condition detector 10 may also be powered by a single 9-volt (V) lithium battery, which couples to the battery indicator LED 22. The 9V battery should be sufficient enough to provide operating power to the dual condition detector 10 for at least ten years, under normal operating conditions. The battery indicator LED 22 and the speaker circuitry 30 provide low battery monitoring notification in the form of visual and audible notification. For example, the speaker circuitry 30 may issue a “chirp” approximately every thirty to forty seconds for a minimum of seven days before the battery completely dies. The battery indicator LED 22 may flash or blink along with the audible “chirp” to alert users that the battery power is low. Preferably, the dual condition detector 10 uses an Ultralife U9VL-J 9V lithium battery manufactured by Ultralife Batteries of Newark, N.Y.

FIG. 2 illustrates an alternative perspective view of the dual condition detector 10 in accordance with the present invention. In this illustration, the light cannon 12 is angled about the adjustable hinge 34 (not shown) within the chamber 36. Accordingly, the light cannon 12 can be angled within the chamber 36 to illuminate an exit at a position beneath the mounted location of the dual condition detector 10. In one embodiment of the present invention, the adjustable hinge 34 is capable of automatically moving the light cannon 12 (or otherwise rotating the light cannon 12) to “walk” a user to an exit, in the event a hazard is detected.

Installation of the dual condition detector 10 preferably includes locating at least one detector 10 in every bedroom or other sleeping area of a structure. Additional detectors 10 may also be placed in stairways as stairways act like chimneys for smoke and heat. It may also be desirable to locate dual condition detectors 10 on at least every floor of a multi-floor or split-level house, in every room where electrical appliances reside (such as portable heaters or humidifiers) and at both ends of a bedroom hallway, especially if the hallway is longer than thirty feet. To ensure proper operation, the dual condition detector 10 should be mounted to the ceiling in the center of a room. In the case of sloped ceilings, the dual condition detector 10 should be mounted at the highest point. Smoke, heat and combustion particles typically rise to the ceiling and spread horizontally thereacross. Locating the dual condition detector 10 in the middle of the room places it closest to all points in the room. The dual condition detector 10 should also be carefully located to avoid thermal barriers. For example, mobile homes, in particular, may not be properly insulated. Extreme heat or cold could be transferred from the outside through poorly insulated walls and roof. This creates a thermal barrier that can prevent smoke from reaching a smoke detector mounted to the ceiling. In such units, the dual condition detector 10 should be installed inside and away from any wall approximately four to six inches. Accordingly, the dual condition detector 10 may be mounted to a wall or ceiling according to the below-described embodiments. Mounting requirements are typically regulated by local or state fire codes.

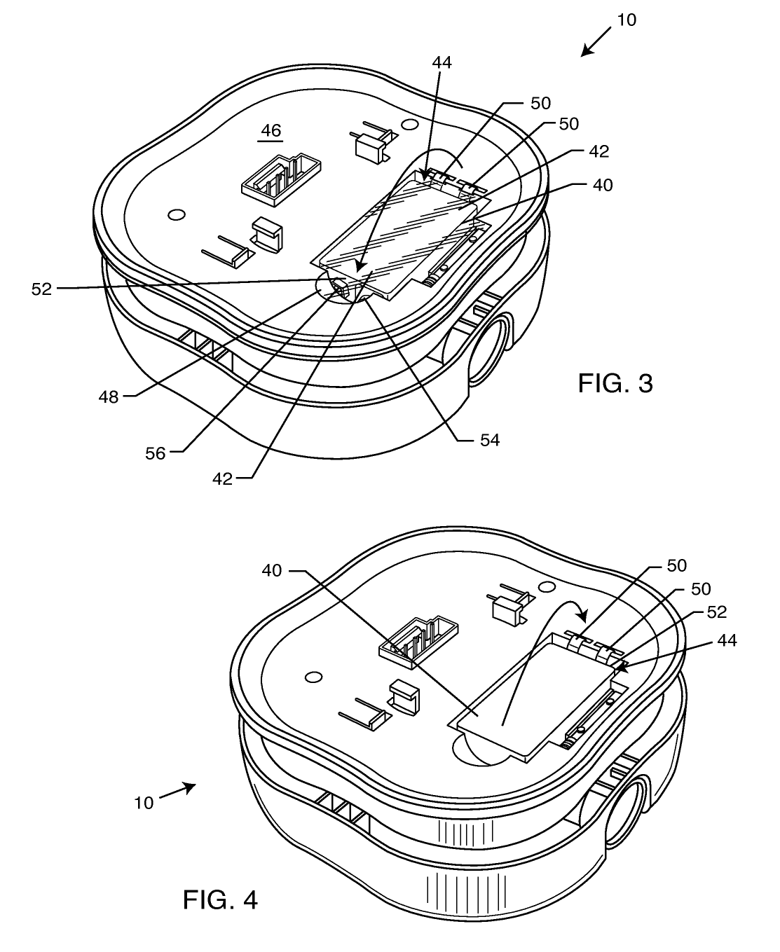

FIG. 3 illustrates the prepackaged dual condition detector 10. The dual condition detector 10 is preferably shipped with a battery 40 wrapped in a cover 42. As shown in FIG. 3, the battery 40 is located within a battery cavity 44 reversed and wrapped in the cover 42. This is to ensure safe shipping of the battery 40 and to prevent accidental discharge of the battery 40 due to activation within the battery cavity 44. Accordingly, the battery 40 must be unwrapped from the cover 42 and reoriented for correct placement in the battery cavity 44. A base 46 of the dual condition detector 10 includes an indentation 48 curved to provide fingertip access to the battery 40 within the battery cavity 44. The indentation 48 is preferably curved as shown in FIG. 3 to maximize engagement of a finger with the battery 40. Accordingly, a user inserts a finger into the indentation 48, pushes the battery 40 back against a pair of electrical connectors 50 and lifts a front end 52 of the battery 40 out from within the battery cavity 44. Once removed, the user may remove the cover 42 from the exterior of the battery 40.

FIG. 4 illustrates insertion of the battery 40 into the battery cavity 44. In this embodiment, a front end 52 of the battery 40 faces the pair of electrical connectors 50. Accordingly, a smaller circular male connector 54 (FIG. 3) and a larger, typically hexagonal or octagonal, female connector 56 come into contact with the electrical connectors 50. This enables the dual condition detector 10 to be powered by the battery 40. The battery 40 should be properly connected within the battery cavity 44 before mounting the dual condition detector 10 to a wall or ceiling. Once the male connector 54 and the female connector 56 engage the electrical connectors 50, the speaker circuitry 30 may issue a brief “beep” to audibly alert the user that the battery 40 has been properly inserted. The “beep” ensures that the dual condition detector 10 is properly powered by the battery 40. The user may optionally depress the test button 38 for approximately three seconds thereby activating the speaker circuitry 30, which issues an alarm horn indicating the battery 40 is connected properly.

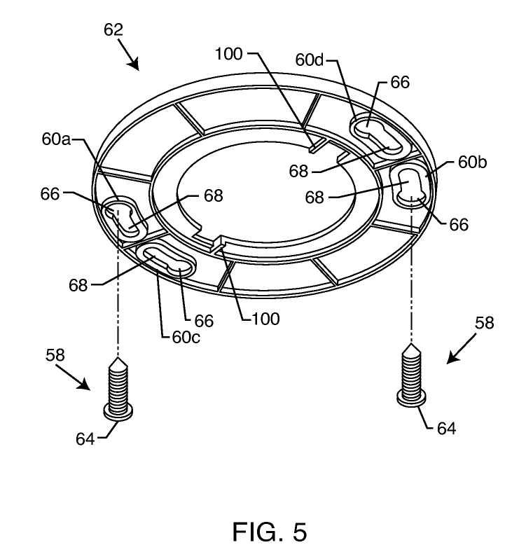

FIG. 5 illustrates a pair of screws 58 that are capable of engaging a slot 60 formed in a mount plate 62. Preferably, the screws 58 engage opposite slots 60, such as engaging either slots 60a, 60b or slots 60c, 60d. The slots 60 are raised within the mount plate 62 such that a head portion 64 of the screw 58 is capable of seating within a reception chamber 66. Preparing to mount the mount plate 62 to a wall or ceiling includes penciling in or tracing the inside location of either the slots 60a, 60b or slots 60c, 60d. The penciled slots enable a user to accurately and specifically identify the locations that the screws 58 should engage the wall or ceiling. Two holes should then be drilled in the location of the reception chamber 66. Preferably, the user drills the holes with a three-sixteenth inch (or five millimeter) drill bit. The screws 58 are then inserted into the drilled holes to threadingly engage the wall or ceiling. The mount plate 62 engages the screws 58 by inserting the head portion 64 into the respective reception chambers 66. The mount plate 62 rotates clockwise to lock the head portion 64 within a reception channel 68. The mount plate 62 remains in a locked position attached to the wall or ceiling because the head portion 64 of the screws 58 reside within the reception channels 68 of the respective slots 60. Rotating the mount plate 62 counterclockwise disengages the screws 58 from the reception channel 68 such that the head portion 64 of the screws 58 may be removed from the mount plate 62 through the reception chambers 66. Of course, the screws 58 remain threadingly engaged to the corresponding mount surface after the mount plate 62 is detached.

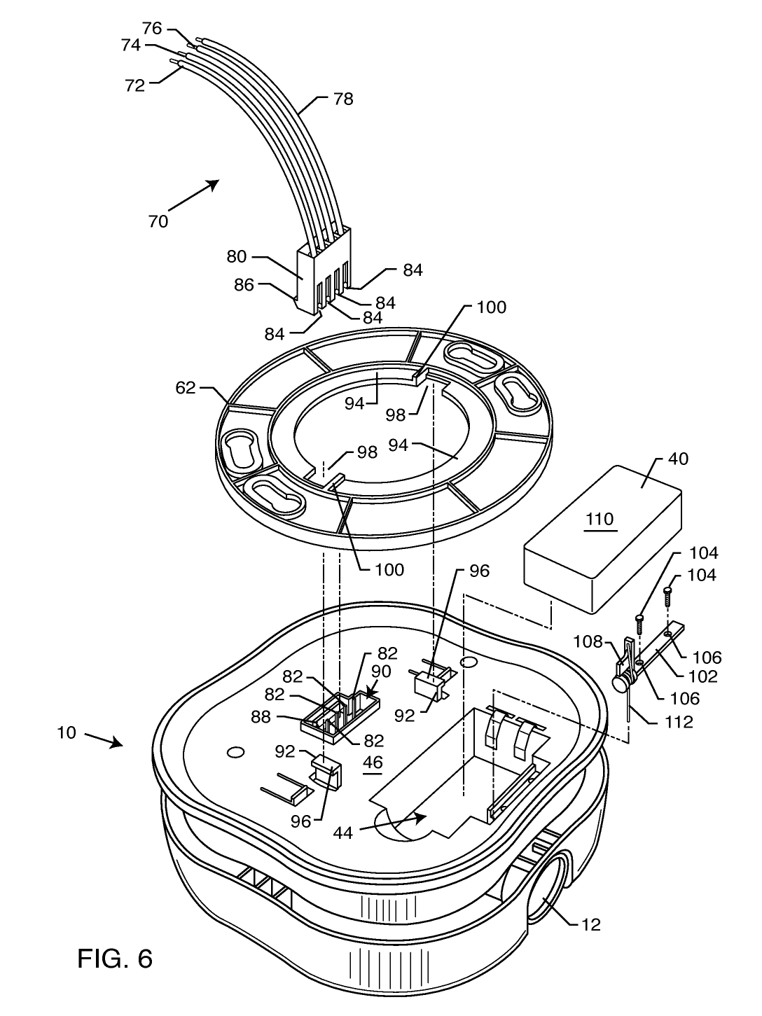

FIG. 6 illustrates a partially exploded perspective view of the dual condition detector 10 and the various subcomponents thereof, including the battery 40, the mount plate 62, and a clip assembly 70. The clip assembly 70 includes four different wires as shown in FIG. 6. Preferably, the wires are color coded to enable a user to easily install the dual condition detector 10 of the present invention. For example, the clip assembly 70 includes a ground wire 72, a communication wire 74, a neutral wire 76 and a power wire 78. In a preferred embodiment, the ground wire 72 is green, the communication wire 74 is yellow, the neutral wire 76 is white and the power wire 78 is black. The ground wire 72 provides a connection between the dual condition detector 10 and the earth. The ground wire 72 provides a path to the earth independent of the current-carrying path in the dual condition detector 10. The ground wire 72 effectively protects against electric shock. The communication wire 74 may be wired with other dual condition detectors 10 of the present invention. In this embodiment, the dual condition detector 10 is capable of communicating with other dual condition detectors, a master controller or a remote security station. Hospitals, hotels, high rise buildings, etc. may have a central control center that operates all the security features of the building (e.g. locks, fire alarms, etc.). Accordingly, the dual condition detector 10 is hard wired to a local communication network with the communication wire 74. Moreover, the neutral wire 76 provides a return for straight currents caused by the dual condition detector 10. This feature prevents malfunction or other electrical problems associated thereto. Appropriately, the power wire 78 supplies AC or DC power to the dual condition detector 10. The power wire 78 ensures that the dual condition detector 10 is powered at all times. In the event of an electrical outage, the battery 40 supplies supplemental power to ensure that the dual condition detector 10 remains in proper working condition. The ground wire 72, the neutral wire 76 and the power wire 78 may be any ground, neutral or power wire readily known in the prior art.

The wires 72, 74, 76, 78 couple to an electrical system in a home or other structure where the dual condition detector 10 is installed. In this regard, each of the wires 72, 74, 76, 78 terminate at one end into a clip 80. Each of the wires 72, 74, 76, 78 may include an attachment mechanism (not shown) to fixedly retain the wires 72, 74, 76, 78 within the clip 80. The clip 80 may also have such an attachment mechanism. The attachment mechanism may be any attachment mechanism known in the art to retain wires in a housing. Accordingly, the attachment mechanism should be capable of conductively coupling the wires 72, 74, 76, 78 to a set of electrical pins 82 protruding out from the base 46 of the dual condition detector 10, through a set of slots 84 in the clip 80. The attachment mechanism is preferably a conductive metal capable of coupling the wires 72, 74, 76, 78 to the electrical pins 82. The clip 80 includes a lip 86 that selectively engages a clamp 88 in the base 46. The clamp 88 is capable of resiliently moving forward and backward within a clip chamber 90. For installation, the lip 86 slides over the clamp 88, thereby pushing it away from the electrical pins 82. Once the clamp 88 bypasses the angled portion of the lip 86, the clamp 88 moves back toward the electrical pins 82 to affixedly retain the clip 80 within the clip chamber 90. Here, the wires 72, 74, 76, 78 are electrically coupled to the electrical pins 82 via the attachment mechanism protruding out from the slots 84. The dual condition detector 10 is properly powered (assuming the corresponding AC or DC power supply is turned “on”) once the clip 80 is connected to the base 46. The dual condition detector 10 can also communicate with other detectors or a central control system.

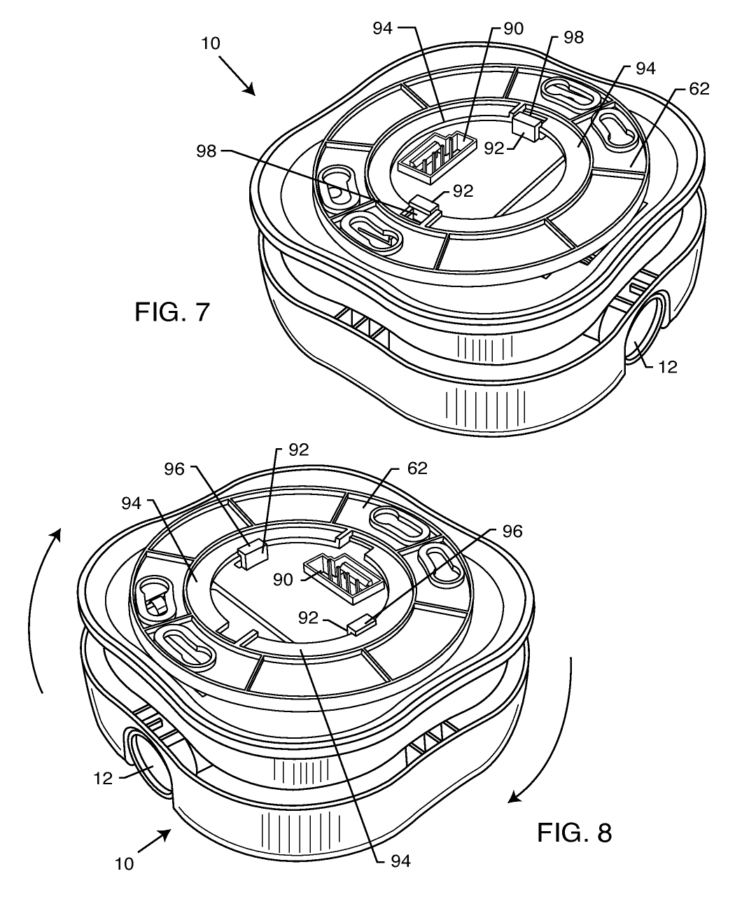

The dual condition detector 10 attaches to the mount plate 62 by a pair of hooks 92 extending from the base 46 that engage a pair of slats 94 in the mount plate 62. In this regard, a flange 96 of the hooks 92 inserts through a gap 98 next to the slats 94 as shown in FIG. 7. Once inserted, the dual condition detector 10 is rotated counterclockwise, as shown in FIG. 8. Preferably, the dual condition detector 10 is rotated approximately one hundred eighty degrees until the flanges 96 contact a pair of stops 100. In this position, the flanges 96 extend over and encompass a portion of the slats 94. This ensures the dual condition detector 10 remains affixed to the mount plate 62. Alternatively, the dual condition detector 10 does not necessarily need to be fully rotated one hundred eighty degrees until the hooks 92 engage the stops 100. The dual condition detector 10 may, instead, be rotated enough to engage the flanges 96 with the slats 94. The flanges 96 need only be sufficiently engaged over the slats 94 to prevent inadvertent dislodgement therefrom through the gaps 98. It is preferred that the dual condition detector 10 be at least rotated ninety degrees relative to the mount plate 62 to ensure secure installation thereto. Partial rotation of the mount plate 62 relative to the dual condition detector 10 also enables a user to properly align the light cannon 12 to an exit.

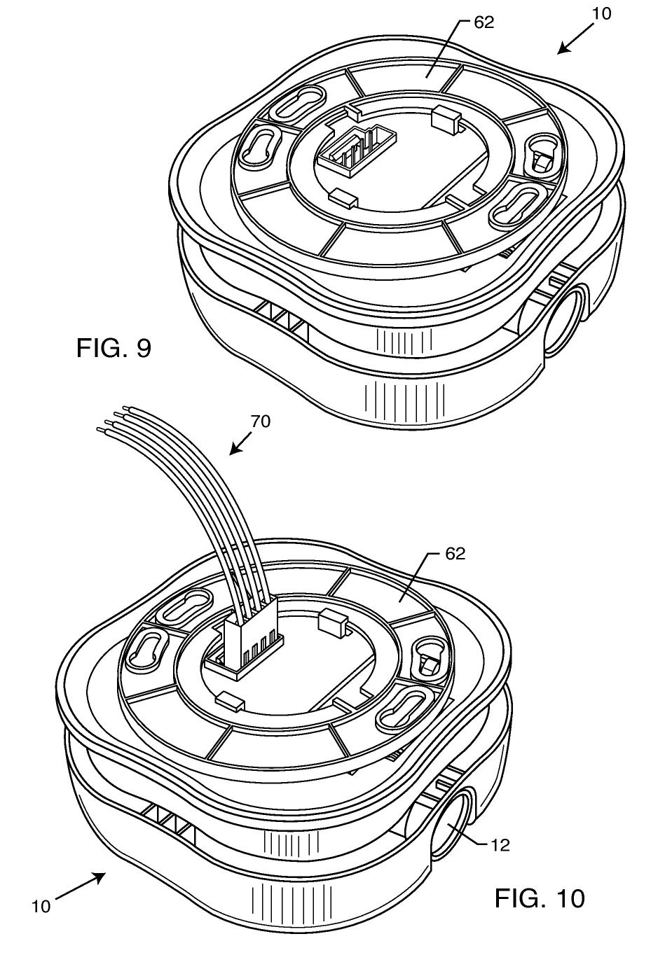

The mount plate 62 remains in a constant position relative to the dual condition detector 10 during installation. This is because the dual condition detector 10 mounts to the mount plate 62, which is already fixedly attached to a wall or ceiling as described above. Hence, a user may position the light cannon 12 to properly illuminate or highlight an exit, in accordance with the present invention, by rotating the dual condition detector 10 relative to the mount plate 62, as shown between FIGS. 7 and 8. The clip assembly 70 (not shown in FIGS. 7 and 8) easily rotates with the dual condition detector 10 because the clip chamber 90 is located to the interior of the mount plate 62. The interior of the mount plate 62 does not have any material that may interfere with rotation of the clip assembly 70. It may be necessary to remove the dual condition detector 10 from the mount plate 62, rotate the dual condition detector 10 one hundred eighty degrees, and reengage the dual condition detector 10 with the mount plate 62, as shown in FIG. 9, to ensure proper location of the light cannon 12 relative to an exit. This feature of the present invention enables a user to position the light cannon 12 of the dual condition detector 10 in just about any position so as to be able to illuminate any exit within a room. FIG. 10 illustrates the dual condition detector 10 fully assembled to the mount plate 62 and the clip assembly 70. The light cannon 12 should be angled to point toward an exit, such as a door knob or window latch, after being attached to a wall or ceiling.

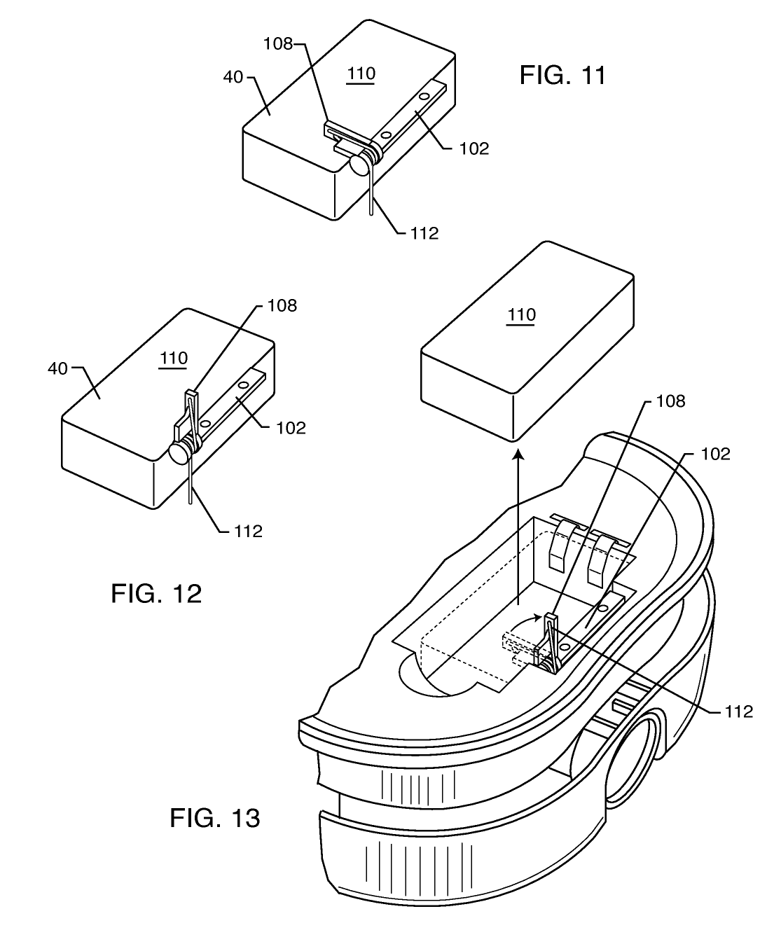

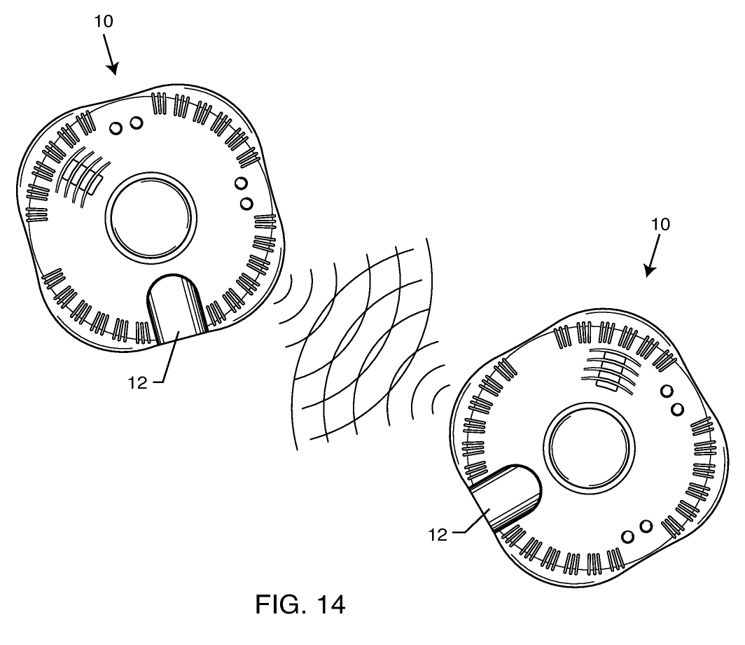

FIGS. 11 and 12 illustrate locking the battery 40 within the battery cavity 44 by use of a battery retainer 102. As best shown in FIG. 6, the battery retainer 102 threadingly engages the base 46 by a pair of screws 104 inserted through a pair of apertures 106. The battery retainer 102 includes an arm 108 that selectively engages a top surface 110 of the battery 40 as illustrated in FIG. 11. A spring 112 bias the arm 108 over the top surface 110 to prevent the battery 40 from inadvertently dislodging from the battery cavity 44. Preferably, the spring 112 is a coil spring or other cantilever spring that exerts a force on the arm 108. Removal of the battery 40 from within the battery cavity 44 requires rotating the arm 108 from a position substantially disposed over the top surface 110 (FIG. 11) to an uncovered position as shown in FIG. 12. Once the arm 108 is no longer encompassing the top surface 110, the battery 40 may be removed from within the battery cavity 44 in the manner illustrated in FIG. 13. Accordingly, the original battery 40 may be tested, recharged or replaced with a new battery for use with the dual condition detector 10.

In another aspect of the present invention, the dual condition detector 10 may wirelessly communicate with another dual condition detector 10 as generally shown in FIG. 14. As described above, each dual condition detector 10 is equipped with the transmitter circuitry 26 and the receiver circuitry 28. The transmitter circuitry 26 is capable of generating a wireless signal capable of being received and processed by the receiver circuitry 28. In this regard, multiple dual condition detectors 10 may wirelessly communicate with one another to cooperatively illuminate a path or an exit. Multiple light cannons 12 may, in a sense, “walk” a person within a structure to an exit. Wireless communication with the transmitter circuitry 26 and the receiver circuitry 28 enables the dual condition detector 10 to alert individuals in another part of a structure of a remote hazard. Preferably, the transmitter circuitry 26 and the receiver circuitry 28 communicate by radio frequency (RF), Bluetooth, Wi-Fi or any other wireless communication means known in the art. Alternatively, the dual condition detectors 10 may also communicate via the communication wire 74 hard wired to the structure.

Although several embodiments have been described in detail for purposes of illustration, various modifications may be made to each without departing from the scope and spirit of the invention. Accordingly, the invention is not to be limited, except as by the appended claims.

1. A dual condition fire/smoke detector system, comprising:
a housing;
a photoelectric sensor disposed within the housing;
a heat sensor disposed within the housing;
a wireless communication system associated with the photoelectric sensor and the heat sensor; and
a light source comprising a strobe light and a laser canon associated with the housing and positioned to illuminate an exit in response to a hazard detected by either one of the sensors.

2. The system of claim 1, wherein the light source is rotatable to illuminate a path to the exit.

3. The system of claim 1, wherein the wireless communication system comprises a receiver and a transmitter.

4. The system of claim 3, wherein the receiver and the transmitter communicate by radio frequency, Bluetooth or Wi-Fi.

5. The system of claim 1, wherein the light source further comprises a high-intensity LED or a light.

6. The system of claim 1, including a power supply comprising a hardwire connection to alternating current and/or a battery disposed in the housing.

7. The system of claim 6, including a lock for releasably retaining the battery in the housing.

8. The system of claim 7, wherein the lock includes a spring loaded arm that engages the battery.

9. The system of claim 1, further including an ionization sensor and/or a carbon monoxide sensor.

10. The system of claim 1, further including means associated with the sensors for minimizing false alarms.

11. The system of claim 1, including a speaker for providing an audible alarm.

12. The system of claim 1, including a remote device in communication with the wireless communication system.

13. The system of claim 12, wherein the remote device comprises a second dual condition detector or a central controller.

14. The system of claim 13, wherein the first and second detectors coordinate to identify the exit.

15. A dual condition fire/smoke detector system, comprising:
a housing;
a sensor comprising a heat sensor and at least one of a photoelectric sensor, an ionization sensor, or a carbon monoxide sensor disposed within the housing;
a wireless communication system associated with the sensor, wherein the wireless communication system comprises a receiver and a transmitter;
a remote device in communication with the wireless communication system; and
a light source comprising a strobe light and a laser canon associated with the housing and positioned to illuminate an exit in response to a hazard detected by either one of the sensors.

16. The system of claim 15, wherein the light source is rotatable to illuminate a path to the exit and further comprises a high-intensity LED or a light.

17. The system of claim 15, wherein the receiver and the transmitter communicate by radio frequency, Bluetooth or Wi-Fi.

18. The system of claim 15, including a power supply comprising a hardwire connection to alternating current and/or a battery disposed in the housing.

19. The system of claim 18, including a lock for releasably retaining the battery in the housing, wherein the lock includes a spring loaded arm that engages the battery.

20. The system of claim 15, further including means associated with the sensors for minimizing false alarms and a speaker for providing an audible alarm.

21. The system of claim 15, wherein the remote device comprises a second dual condition detector or a central controller, wherein the first and second detectors coordinate to identify the exit.
